(19) United States
(12) Patent Application Publication
(10) Pub. No.: US 2014/0111638 A1
(43) Pub. Date: Apr. 24, 2014

(54) Capturing Images after Sufficient Stabilization of a Device

(71) Applicant: ABBYY SOFTWARE LTD., Nicosia (CY)

(72) Inventors: Yuri Isakov, Moscow (RU); Konstantin Tarachyov, Moscow (RU)

(73) Assignee: ABBYY SOFTWARE LTD., Nicosia (CY)

(21) Appl. No.: 13/658,967

(22) Filed: Oct. 24, 2012

(51) Int. Cl. H04N 7/18; H04N 5/225

(52) U.S. Cl. 348/135; 348/345; 348/E05.024; 348/E07.085

(57) ABSTRACT

Described are techniques that guarantee the best opportunity for a camera to capture an image with an acceptable level of quality. Too frequently, images captured with mobile devices such as smartphones and tablet computers fail to capture images of sufficient quality for optical character recognition, for example. Image capture is allowed only after successfully completing a check of sufficient stabilization and focusing of the camera. A variety of sensors may be used to check stability including gyrometers, proximity sensors, accelerometers, and light sensors.

### BACKGROUND OF THE INVENTION

1. Field

Embodiments of the present invention generally relate to the field of controlling the generation of images with a camera, especially those built into portable electronic devices. One object is to substantially reduce blur in images and to encourage generation of images of improved quality for improved results from post-processing and pre-processing particularly for image recognition and optical character recognition (OCR) applications.

2. Related Art

There are many electronic devices that include a built-in camera, including many mobile devices such as laptops, tablet computers, netbooks, smartphones, mobile phones, personal digital assistants (PDAs) and so on. Almost all of these devices possess a camera with an auto-focusing function. A camera's auto-focus mechanism is the system that allows the camera to focus on a certain subject. Through this mechanism, when pressing the shoot button that triggers capture of an image, a sharp image results—an image where there is a defined location of focus in the image.

However, many of these cameras and devices still do not possess a function of photography that adequately provides auto-focusing and thereby a user is allowed to take excessively blurry photographs. For example, these devices do not possess the function of, or make an adequate check of, auto-focusing just at the moment of taking the photo (shot). That means that a shot is performed merely and directly by triggering a shot button, regardless of whether auto-focusing was achieved or not. That is why to receive a sharp image a user should wait for auto-focusing of the device to perform its function.

There are other sources of blur in images taken with currently popular portable devices. Some of the popular camera-enabled devices employ complementary metal oxide semiconductor (CMOS) active pixel sensors to capture images. Often, these are small sensors and have a tendency to record blurry images unless exposed to relatively strong light.

The lack of the above-described function—auto-focusing at the moment of taking a shot—is evident in such devices as iOS-based portable electronic devices, netbooks, laptops, tablets, etc. Currently, these devices do not support auto-focusing at the moment of photography. Consequently, these devices require a user to wait for the camera to select a focus or require user assistance to focus the camera of the device on a subject before making, triggering or shooting a sufficiently sharp image (photos with minimal blur). Taking images in this manner does not guarantee sharp images because a user's hand can shake in the moment of capturing an image or photograph. Blurry images taken in this manner are generally unusable for the purpose of subsequent OCR or text recognition. There is substantial opportunity to improve the photography related to portable electronic devices. Non-blurred, sharper images are needed from portable electronic devices including from those devices that do not employ auto-focusing at the moment of taking a shot.

### SUMMARY

There are many factors that can cause blur in photographic images including relative motion between an imaging system or camera and an object or scene of interest. An example of a motion-blurred image is illustrated in FIG. 2A. Motion-blurred images commonly occur when the imaging system is moving or held by a human hand in moderate to low levels of light. Optical character recognition (OCR) of images of blurred text may be impossible or at best may yield inaccurate. Even not subjected to OCR, blurred text may be impossible for a person to read, recognize or use.

In one embodiment, the invention provides a method that includes instructions for a device, an operating system, firmware or software application that guarantee the best opportunity for a camera to receive or capture an image with a very good or acceptable level of quality. Photography is allowed or performed only after successfully completing a check of sufficient stabilization and focusing of the camera. A result of this invention is an image with sufficiently clear text for subsequent, accurate recognition of the text.

### BRIEF DESCRIPTION OF THE DRAWINGS

FIG. 1 shows an example of an electronic device having displayed thereon a representation of photographed text as captured by a camera without a function of auto-focusing just at the moment of pressing a shot button of camera (at the moment of capturing an image).

FIG. 2A shows an actual example of a blurred photograph of text made by a camera without a function of auto-focusing just in the moment of pressing a shot button of camera for capturing images.

FIG. 2B shows an actual example of the same subject as shown in the photograph taken by the same camera that captured the photograph of FIG. 2A, but with implementation of the disclosed invention.

FIG. 3 shows a flowchart of a method in accordance with an embodiment of the present disclosure.

FIG. 4 shows a diagram indicating when a sensor signal indicates that a camera is likely in a condition to take a picture (capture an image) without substantial blur—at various thresholds of noise.

FIG. 5 shows a diagram or plot indicating a reading or measurement of noise from each of multiple sensors.

FIG. 6 shows an exemplary hardware for implementing the present disclosure.

### DETAILED DESCRIPTION

In the following description, for purposes of explanation, numerous specific details are set forth in order to provide an understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, and are not separate or alternative embodiments mutually exclusive of other embodiments. Moreover, various features are described which may be exhibited by some embodiments and not by others. Similarly, various requirements are described which may be requirements for some embodiments but not other embodiments.

Advantageously, the present invention discloses methods and devices that facilitate reduction in the number of blurred images being taken. These methods are effective for a variety of devices including those that do and do not support or implement auto-focusing at the moment of taking a shot.

There are many causes of blur in images. One of the principal causes is motion of an image capturing device, such as when moving a device at the instant of capturing images in relatively moderate to low levels of light for example. This type of blur is referred to as motion blur. This type of blur is almost always undesirable and detrimental to subsequent processing or consumption.

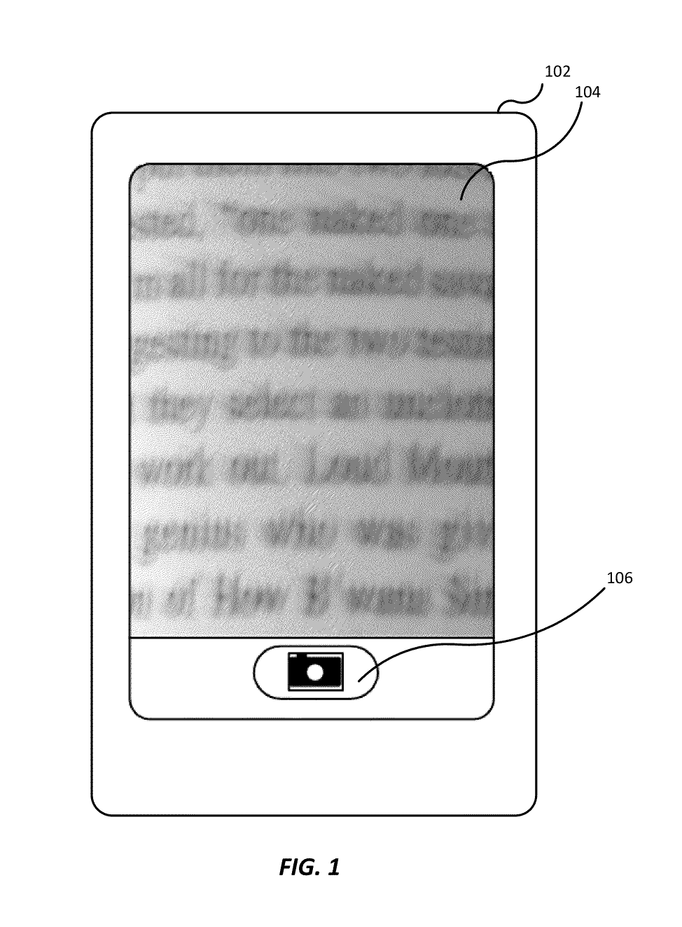

Referring now to FIG. 1, there is an example of an electronic device 102 comprising a display screen 104 and camera button 106 for triggering, making or shooting of an image with a camera (not shown) that is part of the electronic device. The button 106 may be software-generated (virtual) or actual (e.g., physical button associated with the chassis of the electronic device 102). The content presented on the screen 104 may be captured or generated by a camera application that sends an image of a subject of interest to the display screen 104.

The electronic device 102 may comprise a general purpose computer embodied in different configurations such as a mobile phone, smartphone, cell phone, digital camera, laptop computer or any other gadget having a screen and a camera, or access to an image or image-generating device or component. A camera or scanner allows converting information represented on—for example—paper into a digital form.

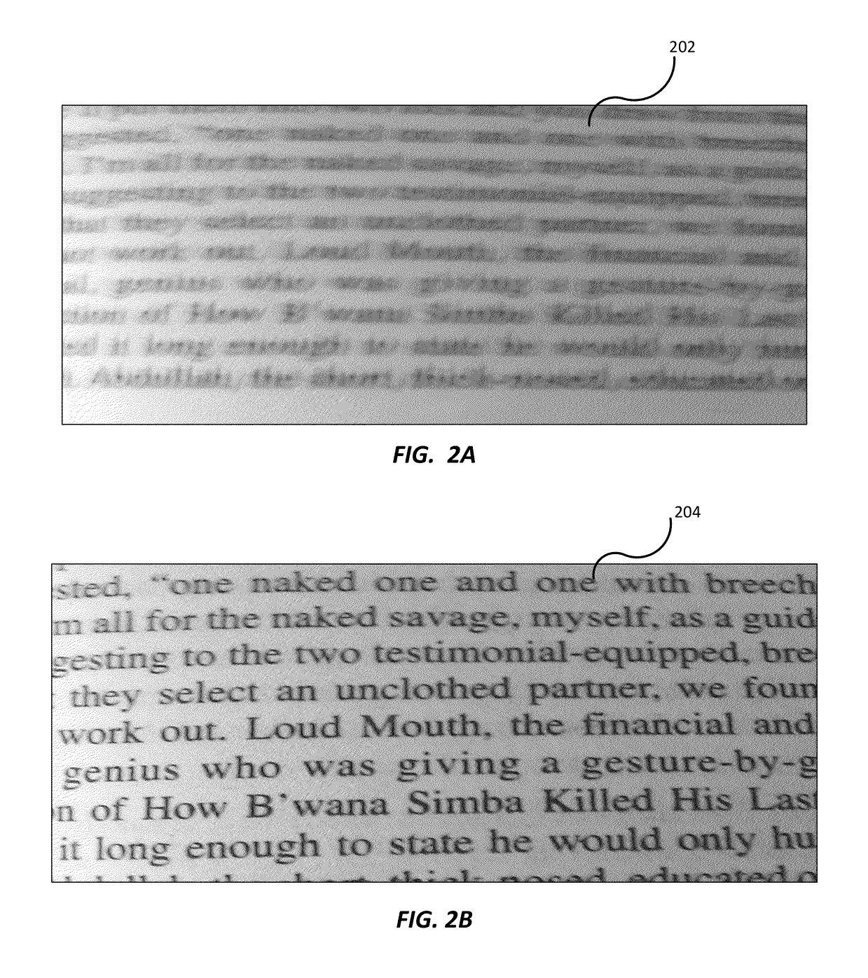

FIG. 2A shows an actual example of a blurred photograph of text 202 made by a camera without a function of auto-focusing just in the moment of pressing a shot button of camera. This image is not acceptable for subsequent accurate optical character recognition of the text 202 represented in it. As can be seen, characters are blurred and not easily decipherable even for the human eye.

In contrast, FIG. 2B shows an actual example of the same subject as shown in the photograph taken by the same camera that captured the photograph of FIG. 2A, but with implementation of the disclosed invention. The image of FIG. 2B is relatively sharp, and the text is relatively easy to read by the human eye and is likely recognized by many OCR systems.

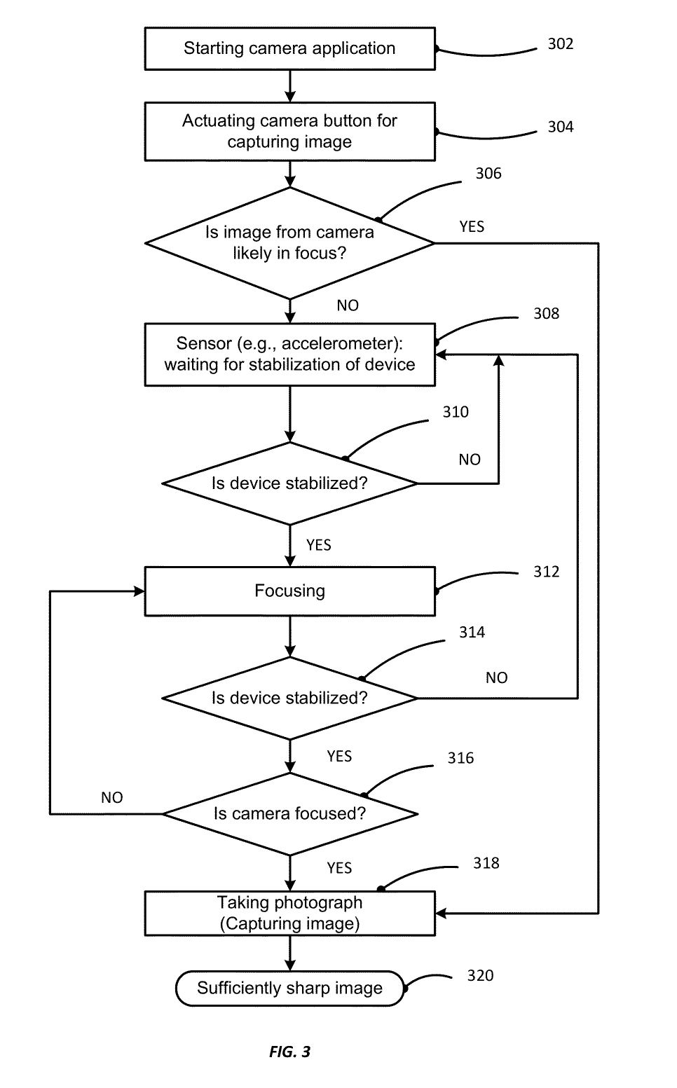

Referring now to FIG. 3, there is shown a flowchart of operations performed in accordance with one embodiment of the invention. One way to initiate the method includes starting of a camera application 301 or an application that has access to or is capable of accessing the controls of a camera associated with an electronic device.

Next, a user chooses a subject of interest and directs the camera for taking or capturing an image. For example, a viewfinder may be directed to a portion of text or page of a document. Then, at step 302, a user presses or actuates a button that ordinarily triggers capture of an electronic image. An exemplary button 106 is shown in FIG. 1; a user taps the button 106 on a designated area of the touch screen 104 to take a shot. Following this step, ordinary devices that do not practice the invention, without a function of auto-focusing just in the moment of pressing a shot button of camera, capture an image. The image captured in such manner is likely to have very poor quality. That is why without implementation of the invention a user should wait for a moment that in which a proper focus is obtained by the camera. Often, with modern electronic-sensing cameras, proper focus only occurs after waiting for 1-2 seconds or some delay. Despite some advances, electronic capture of images is substantially slower than traditional film cameras that can use chemicals to immediately capture and record incident light. With electronic cameras, a user should wait to press the “shutter” button until focusing has been achieved in order to receive and capture a sharp image. While reference to “shutter” is mentioned, many modern cameras, including those that are based on CMOS active pixel sensors, do not use a traditional shutter or moving mechanical block that prevents light from reaching the electronic sensor. Shutter button or camera button as used herein refers to a virtual or real button that triggers capture of an electronic image. The implementation of the disclosed invention helps to avoid shortcomings of electronic capture of images, especially when using portable electronic devices that include a camera.

Returning to FIG. 3, there is shown a flowchart of operations performed in accordance with one embodiment of the invention.

The starting of a camera application 302 starts the disclosed method.

After that, a user chooses the subject of interest and directs the camera to a photo. For example, the subject of the photo may be a text or something else. Then at the step 304, the user actuates a camera button 106 (virtual or real) or taps the touch screen 104 for capturing image. Following this trigger, devices without a function of auto-focusing at the moment of triggering actually trigger capture of a photo. Taken in such manner, an image may be of very poor quality. That is why without implementation of the invention a user should wait by himself for the moment when auto-focusing has engaged and then should press the button only after sufficient focusing has occurred to receive a sharp image. In contrast, the implementation of disclosed invention helps avoid these shortcomings. According to the invention the next steps are performed.

If at the time that a capture button of a camera is pressed (304) the camera is already focused (the image is in focus) at 306, then photography is performed (318): an image is captured (318) and the device captures or receives a sharp image at step 320.

Otherwise, if a camera is not properly focused, an accelerometer or other sensor 308 starts to work. At step 308, the system tracks the sensor and seeks for a moment based on the readings of accelerometer (sensor) for a moment when the electronic device is stabilized. The stabilized state means that there is substantially little shaking of the device. The sensor provides feedback to the device and/or camera.

The feedback includes a signal that the device and/or camera is likely experiencing motion and there is a substantial likelihood of motion blur if an image is captured at that time or instant. The sensor or sensor system allows the device to wait, based on readings of the sensor (e.g., accelerometer, gyrometer), for the next moment when the electronic device and/or camera is sufficiently stabilized. The stabilized point means, for example, that there is relatively little shaking of the device and/or camera.

In one implementation, substantially simultaneously at the time the sensor starts to work, a timer starts to work. The timer keeps track of the time during which the device and/or camera seeks for a moment of sufficient stabilization. If a predetermined time limit for stabilization is exceeded, the process of photography stops. The user must again engage or trigger the device to take a photograph. In a preferred implementation, the device or camera provides a mechanism to override the stabilization checking.

From the point of view of a user, a user activates the button, and the device waits for a first available time for when there is a window of opportunity or moment of opportunity to capture a focused image. An exemplary scenario is illustrative. For a passenger riding in a vehicle, a user pulls out her mobile phone and desires to take a picture of a sign posted along side of the road while the car is moving. At this time, the mobile phone is moving around in the hands of the user, and the car is experiencing some ordinary turbulence as it advances on the road. The user activates a camera application on the mobile phone. During this time, the mobile phone activates or powers up the camera and related circuitry. The user points the mobile phone out the window of the vehicle. An image immediately captured may be blurry. Thus, the device waits, and a timer starts. Over the next few seconds, if the mobile phone (camera)—in the vehicle and in the control of the passenger (user)—reaches a sufficiently stable state, and there is sufficient incident light, the sensor in the mobile phone communicates that the camera is free to take a photograph. Assuming that the vehicle is moving slowly enough, an image captured at this instant is likely to be sufficiently in focus.

In the case of failure, a user must press the shoot button or tap the touch screen to run this process again. The limits of the timer may be preliminary specified by the user. For example, the device or camera may wait for one or more stable opportunities within 5 seconds, or 10 seconds. This function is useful in conditions where there is steady or unpredictable shaking, for example in a subway. Therefore, it is impossible to take a sharp image of the text in some cases because there may be excessive movement or instability of the electronic device or camera.

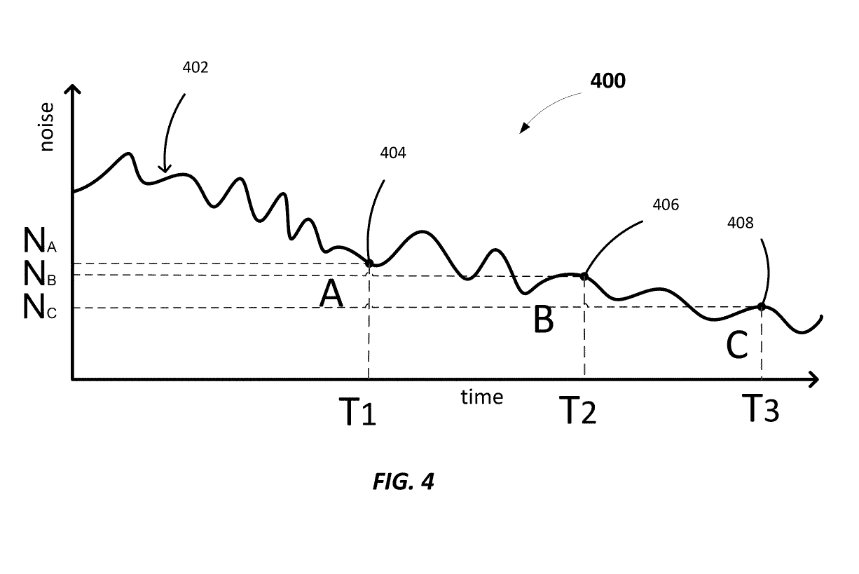

In one embodiment, the system implements a plurality of thresholds for levels of noise corresponding to shaking or movement of the electronic device or camera. FIG. 4 demonstrates a plot 400 of an exemplary relationship 402 between a level of noise received from a sensor or acquired from sensor readings over time. As shown in FIG. 4, the level of noise generally decreases over time and is shown for purposes of illustration only, and therefore does address all scenarios. Sensors may include, among others, accelerometers, gyrometers, proximity sensors and light sensors. With reference to FIG. 4, Point A (404) on the plot 400 corresponds to a first threshold of noise, one required or acceptable for acquiring an image of a satisfactory quality. Several images may be captured over a time interval (e.g., one that includes T₁, T₂ and T₃). The period of relative stability includes identifying intervals from the recording of the signal from the sensor that indicates an interval of at least a duration D. The state of stability means (in one implementation) that signals from the sensor remain within a range of values R during all times sampled in the interval of duration. The image captured before or at the end of a first period of time T₁ will be stored only temporarily in a cache-memory as long as an image of a better quality is captured. Point B (406) on the plot 400 corresponds to a second threshold of noise, one required for acquiring the photos of a good quality or better quality than at Point A (404). If the image of a good quality is received, such that the image acquired earlier of satisfactory quality is no longer the best captured image and may be deleted from memory. The image of a good quality captured at moment T₂ is stored temporarily in the cache memory as long as an image of an ideal or best quality is captured at a later time. Point C (408) on the plot 400 corresponds to a third threshold of noise, one required for acquiring the images from a camera where the images are of a preferred, ideal or best quality possible from the particular camera. If the image of an ideal quality is captured, the one or more images acquired earlier of a sufficient or good quality may be deleted from the memory. Each plot may be different depending on one or more variables including the type of camera, the amount of incident light associated with the particular image, etc. Parameters corresponding to points A, B and C (corresponding to times T₁, T₂ and T₃) may be provided by default, but they may be preliminarily selected or modified in the settings of the system of the electronic device or in an application, firmware, etc. associated with the camera. In an alternative implementation, the parameters may be obtained by training the device. Also, the number of thresholds for a time interval may be more or less than the three mentioned above.

Thresholds for noise based on sensor readings may be specified preliminarily according to different types of subjects captured in images. For example, the level of noise for a text-based image destined for recognition must be much less than the level for a picture with no text elements. The level of noise concerning subsequent recognition of a textual image (text-based image, or an image that includes text) is important for acquiring accurate recognition of the corresponding text. Blurred textual images require much more computational resources from the electronic device to be perfectly or adequately recognized. Also, the rate of blur may be so high that recognition may not be possible at all. Consequently, textual images (images that include text) must be acquired with the smallest level of blur as possible. In contrast, some images, even some that include text, may have some level of blur, if the best quality image is not required for subsequent processing (e.g., printing, sharing via social media, archiving) for the particular images. The level of noise for each kind of image may be preliminarily specified by a user in one or more settings of the system, or may be programmatically obtained by training the device. One way in which the level of acceptable noise may be specified is to allow a user to select a quality of picture that is desired. For example, if a user desires to take landscape photographs of mountains, the user selects a “non-text” option. In another example, a user desires to take a series of pictures of receipts for submission of the information (text) to a finance system. In this example, the user would select a “text-based picture” option. By doing so, the device is programmed to detect a sufficiently stable moment in which to take photographs that are receptive to OCR.

In another embodiment, readings or recordings of a light sensor of an electronic device also may be applied for acquiring images of a good quality or of sufficient quality. Generally, the quality of each image increases with the level of light. The light sensor helps to set optimal values of brightness and contrast for the certain level of illuminance. The light sensor allows the electronic device or camera to determine thresholds of illumination for subsequent acquiring of images. For example, the values of thresholds may be specified in such manner that the electronic device allows triggering of the camera to capture images only when there is a sufficiently high level (amount) of light.

The readings of two or more sensors (e.g., light sensor and accelerometer) may be combined for sending feedback to the electronic device for eventual triggering of the camera for taking shots (capturing images).

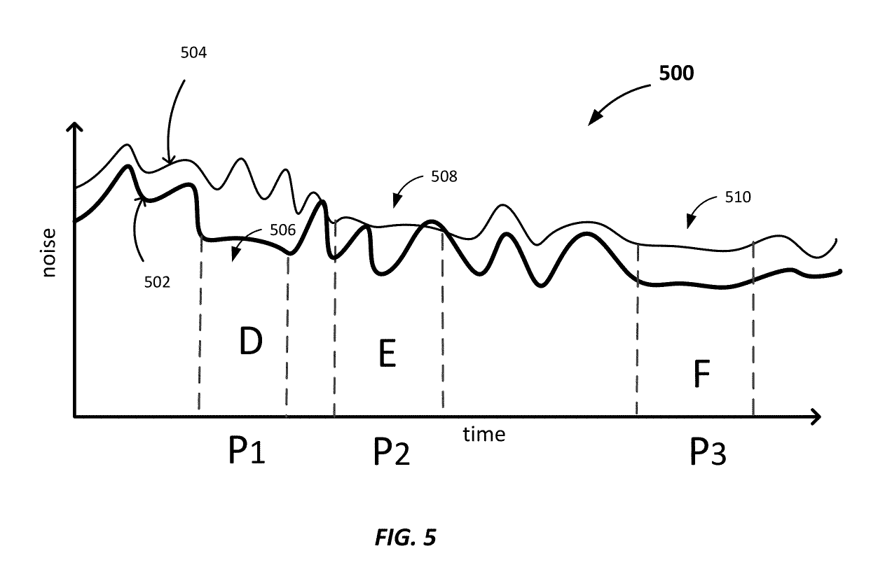

FIG. 5 shows a diagram or plot 500 indicating a reading or measurement of noise from each of multiple sensors 502, 504. For example, a first sensor could be a first accelerometer, and a second sensor could be a second accelerometer. With reference to FIG. 5, a first measurement 502 indicates an amount of noise or instability associated with the camera of the electronic device (or associated with any images taken at a given time with said camera). Similarly, a second measurement 504 indicates an amount of noise or instability with the electronic device or camera (or associated with any images taken at a given time with said camera). If the electronic device were to follow or track a first signal 502 to find a first opportunity for capturing a sharp image, the first opportunity might be during period P₁ indicated in range D (506). However, the second noise signal 504 indicates that the electronic device may be experience shaking during P₁. Therefore, this period P₁ may not be optimal for capturing a sharp image. Similarly, if the electronic device were to follow or track a second signal 504 to find a first opportunity for capturing a sharp image, the first opportunity might be during period P₂ indicated in range E (508). The first noise signal 502 indicates that the electronic device may be experience shaking during P₂. Therefore, this period P₂ may not be optimal for capturing a sharp image. According to one implementation of the invention, a first opportunity when both signals 502, 504 indicate a first optimal period may be during a third period P₃ in range F (510). Using two or more signals may improve recognizing opportunities for capturing a sufficiently sharp image, especially one with sufficient quality for OCR processing. Also readings of three or more accelerometers may be combined in the disclosed invention to receive the sharp image. Other combinations of various types of sensors may be used.

With reference again to FIG. 3, based on the readings 308 of the accelerometer, if the system did not detect any shaking (based on a threshold) after sensing actuation of the shoot button (i.e., the electronic device detects that it is sufficiently stabilized), the system starts to focus 312. Otherwise if the electronic device is not stabilized the system returns to the step 308 and starts to wait for the stabilization of device.

After the focusing at step 312 the system is checked whether the device is stabilized at step 314. In the case when the device is not stabilized, the system returns again to step 308. If the electronic device is stabilized, the system checks whether the camera is focused at step 316.

If the camera is focused, photography/taking of an image 318 is performed automatically or programmatically. Otherwise, the system returns to the step of focusing 312. So if during the process of focusing shaking starts, the system is returned to the step of tracking accelerometer readings for the waiting a moment when the electronic device with camera is stabilized.

The above-described invention helps to identify opportunities to take a photograph (such as of text for example) without substantial blur excepting such human factors as shaking of a user's hand in typical circumstances related to photography. Otherwise, if the circumstances are not suitable for photography, shooting is not enabled by functionality consistent with that described herein.

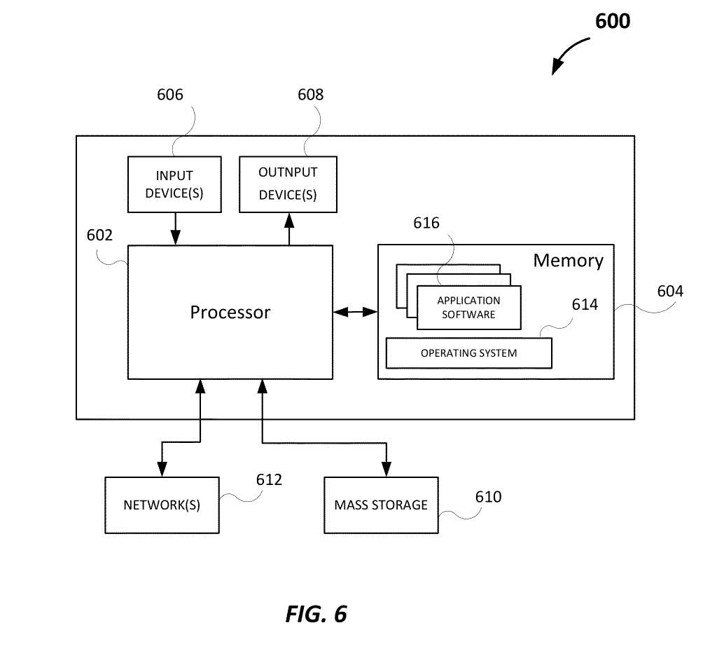

FIG. 6 shows hardware 600 that may be used to implement the user electronic device 102 in accordance with one embodiment of the invention in order to translate a word or word combination and to display the found translations to the user. Referring to FIG. 6, the hardware 600 typically includes at least one processor 602 coupled to a memory 604 and having touch screen among output devices 608 which in this case is serves also as an input device 606. The processor 602 may be any commercially available CPU. The processor 602 may represent one or more processors (e.g. microprocessors), and the memory 604 may represent random access memory (RAM) devices comprising a main storage of the hardware 600, as well as any supplemental levels of memory, e.g., cache memories, non-volatile or back-up memories (e.g. programmable or flash memories), read-only memories, etc. In addition, the memory 604 may be considered to include memory storage physically located elsewhere in the hardware 600, e.g. any cache memory in the processor 602 as well as any storage capacity used as a virtual memory, e.g., as stored on a mass storage device 610.

The hardware 600 also typically receives a number of inputs and outputs for communicating information externally. For interface with a user or operator, the hardware 600 usually includes one or more user input devices 606 (e.g., a keyboard, a mouse, imaging device, scanner, etc.) and a one or more output devices 608 (e.g., a Liquid Crystal Display (LCD) panel, a sound playback device (speaker). To embody the present invention, the hardware 600 must include at least one touch screen device (for example, a touch screen), an interactive whiteboard or any other device which allows the user to interact with a computer by touching areas on the screen. The keyboard is not obligatory in case of embodiment of the present invention.

For additional storage, the hardware 600 may also include one or more mass storage devices 610, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 600 may include an interface with one or more networks 612 (e.g., a local area network (LAN), a wide area network (WAN), a wireless network, and/or the Internet among others) to permit the communication of information with other computers coupled to the networks. It should be appreciated that the hardware 600 typically includes suitable analog and/or digital interfaces between the processor 602 and each of the components 604, 606, 608, and 612 as is well known in the art.

The hardware 600 operates under the control of an operating system 614, and executes various computer software applications 616, components, programs, objects, modules, etc. to implement the techniques described above. In particular, the computer software applications will include the client dictionary application and also other installed applications for displaying text and/or text image content such a word processor, dedicated e-book reader etc. in the case of the client user device 102. Moreover, various applications, components, programs, objects, etc., collectively indicated by reference 616 in FIG. 6, may also execute on one or more processors in another computer coupled to the hardware 600 via a network 612, e.g. in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks (DVDs), flash memory, etc.), among others. Another type of distribution may be implemented as Internet downloads.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

We claim:

1. A method for capturing an image with a camera component of an electronic device, the method comprising:
(1) sensing a signal associated with capturing an image with the camera of electronic device;
(2) sensing a sensor signal from a sensor associated with the device;
(3) identifying a state of relative stabilization of the electronic device based on said sensed sensor signal;
(4) checking an indication of focusing of the camera component in the state of relative stabilization of the device; and
(5) triggering capture of the image with the camera component of the electronic device.

2. The method of claim 1, wherein sensing the sensor signal associated with capturing the image with the electronic device includes recording the sensor signal.

3. The method of claim 1, wherein the method further comprises sensing a second signal associated with capturing the image with the camera of electronic device, and wherein said identifying the state of relative stabilization of the electronic device is performed based on the second signal.

4. The method of claim 1, wherein identifying the state of relative stabilization is performed substantially simultaneously with a timer.

5. The method of claim 4, wherein the method further comprises:
defining a maximum time in which to identify said state of relative stability;
tracking with said timer a time during which the electronic device seeks for the state of relative stabilization; and
providing a signal to cease sensing of said sensor signal from the sensor associated with the device when the maximum time is reached or exceeded.

6. The method of claim 5, wherein the maximum time in which to identify the state of relative stability is a default value or a preset value.

7. The method of claim 5, wherein tracking with said timer the time during which a first image is captured at a moment when a state of relative stability is acceptable, wherein said first image is temporarily stored in a cache-memory, and seeking for a better state of relative stability is performed until the end of the maximum time as long as an image of a better quality is captured.

8. The method of claim 1, wherein triggering capture of the image with the camera is performed only when the indication of focusing of the camera component is positive.

9. A method for capturing an image with a camera of a mobile electronic device, the method comprising:
(1) sensing a signal associated with capturing an image with the camera;
(2) monitoring a signal from a sensor associated with the device;
(3) identifying a period of relative stability greater than a time T from the recording of the signal from the sensor that indicates an interval of relative stability (“first period”);
(4) performing an automatic focusing function of the camera in the period of relative stability; and
(4) triggering capture of an image with the camera.

10. The method of claim 9, wherein time is a time associated with a first available interval of relative stability.

11. The method of claim 9, wherein time is a time associated with a second or subsequent available interval of relative stability, and wherein said monitoring the signal from the sensor includes recording the signal in a memory of the electronic device.

12. The method of claim 9, wherein time is a time when the signal from the sensor transitions within an acceptable measure related to a measure of noise in the camera.

13. The method of claim 9, wherein time is a time when the signal from the sensor transitions within an acceptable measure related to a predicted measure of noise in an image not yet taken by the camera.

14. The method of claim 9, wherein the period of relative stability includes identifying an interval from the recording of the signal from the sensor that indicates an interval of at least a duration, wherein the signal from the sensor remains within a range of values during all times sampled in the interval of duration.

15. The method of claim 9, wherein the method further comprises:
performing optical character recognition (OCR) of the captured image.

16. The method of claim 9, wherein the method, after sensing the signal associated with capturing an image with the camera, further comprises:
determining a level of ambient light;
determining whether the level of ambient light exceeds a pre-determined threshold;
when the level of ambient light fails to exceed the predetermined threshold, performing steps (2), (3) and (4).

17. The method of claim 9, wherein the method further comprises:
preventing said capture of the image until said identifying the period of relative stability.

18. The method of claim 9, wherein the method further comprises:
substantially concurrently as step (2), recording a signal from another sensor associated with the device (“second signal”);
identifying a period of relative stability greater than another time from the recording of the second signal that indicates an interval of relative stability in terms of the second signal (“second period”); and
preventing said triggering of the capture of the image until the second period is identified.

19. The method of claim 9, wherein the method further comprises:
substantially concurrently as step (2), recording a signal from another sensor associated with the device (“second signal”);
identifying a period of relative stability greater than another time from the recording of the second signal that indicates an interval of relative stability in terms of the second signal (“second period”); and
preventing said triggering of the capture of the image until the second period is identified and until the second period overlaps the first period.

20. An electronic device for capturing images, the device comprising:
a sensor capable of generating a signal related to motion of the electronic device;
an image capturing component;
a processor;
a memory electronically in communication with the sensor, the image capturing component, and the processor, wherein the memory is configured with instructions to perform a method, the method including:
detecting a signal indicative of a trigger to capture an image with said image capturing component;
monitoring a signal associated with the sensor;
identifying a period of relative stability greater than a time from the monitoring of the signal associated with the sensor that indicates an interval of relative stability (“first period”);
triggering capture of an image with the image capturing component; and
storing a representation of the image in the memory.

21. The electronic device of claim 20, wherein time is a time associated with a first available interval of relative stability.

22. The electronic device of claim 20, wherein time is a time associated with a second or subsequent available interval of relative stability, and wherein said monitoring the signal associated with the sensor includes recording the signal in the memory of the electronic device.

23. The electronic device of claim 20, wherein time is a time when the signal associated with the sensor transitions within an acceptable measure related to a measure of noise associated with capturing an image with the image capturing component.
